(19) United States
(12) Patent Application Publication
(10) Pub. No.: US 2009/0300649 A1
(43) Pub. Date: Dec. 3, 2009

(54) Sharing An Object Among Multiple Applications

(75) Inventors: Burra Gopal, Redmond, WA (US); Sander M. Viegers, Seattle, WA (US); Jeff Keyes, Redmond, WA (US); Chris Alan Keyser, Snoqualmie, WA (US); Jagdish Singh, Hyderabad (IN)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/130,568

(22) Filed: May 30, 2008

(51) Int. Cl. G06F 9/46

(52) U.S. Cl. 719/313

(57) ABSTRACT

Allowing multiple software applications to share an object of an application system is provided. Each of the multiple software applications is associated with a line of business (LOB) system and is associated with a solution ID. The application system may receive a request to establish a first binding between the object and a first LOB entity instance for a first software application. The first binding between the object and the first LOB entity instance may then be established. The application system may further receive a request to establish a second binding between the object and a second LOB entity instance for a second software application. The second binding between the object and the second LOB entity instance will be established when the first and second software applications have matching solution IDs and compatible sharing levels to the object. The application system may therefore establish user interface and data sharing between the first and second LOB entity instances in the object.

### BACKGROUND

Software applications enable the production of various useful objects, such as word processing documents, spreadsheets, slide presentation slides, database files, electronic mail items, calendar objects (e.g., appointments and tasks), contact information, desktop publishing documents, and more. In developing software applications for producing such objects, it is useful to allow line of business (LOB) information that is relevant to a given object to be presented in the context of the object. For example, if a user is working on a word processing application object in the form of a business contract document, it may be useful to present the user information about customers or suppliers being targeted by the business contract within, near, around or adjacent to the object (e.g., contract document) rather than redirecting the user to a portal or link for finding the relevant LOB information. Similarly, if a user is looking at a particular expense report presented in the form of an email, all relevant information in a LOB system about the report, for example, information about employees involved in purchases/transactions should be presented as a part of the context of that email in the corresponding email application, instead of forcing the user to go elsewhere for that information. That is, it is undesirable to require the user to leave the familiar surface and user interface (UI) of his/her email application to access a LOB system that has the needed information. The LOB system should “come to” the user within the appropriate context.

In addition, there may be many LOB processes/systems with LOB information that is relevant to a particular application object (e.g., business contract). For example, LOB information relevant to a given business contract object may be found in a customer relationship management (CRM) module, a supply chain management (SCM) module, and a human resources (HR) module of a particular LOB system. Relevant actions that may be taken on the example business contract (and that should be presented to the user in the context of the example business contract) may include one or more processes in all of these modules. In other words, it is a very common scenario for a single object (e.g., document) to be relevant to multiple business processes and/or information in multiple LOB modules or systems. In most cases, LOB vendors create different business applications (BA) to deal with different LOB modules or systems because these LOB modules and systems need different kinds and levels of expertise and typically also evolve (and may be purchased) independently of each other. Typically, each BA extends a particular object (for example, business contract document prepared with a word processing application) in a special way that is unique to the LOB functionality being exposed by that BA, and the BA expects that its extension is preserved when other BAs extend the same object. Objects that are extended by a BA to provide additional LOB functionality are often called “extended objects.” Sometimes such objects are referred to as “bound objects” which indicates that a given object depends on some information in a LOB system and is bound by the LOB system. That is, a “bound object” is not a free-form Application object that a user can manipulate independently without creating side-effects outside the user's own workspace.

There is a need for information isolation and protection when an object is shared among multiple software applications. There is also a need for a user-interface interaction pattern between software applications. In addition, there is a need for keeping an object synchronized with associated LOB information when any associated LOB information changes.

It is with respect to these and other considerations that the present invention has been made.

### SUMMARY

This summary is provided to introduce a selection of concepts in a simplified form that are further described below in the Detailed Description. This Summary is not intended to identify key or essential features of the claimed subject matter, nor is it intended to be used in any way as to limit the scope of the claimed subject matter.

Embodiments of the present invention solve the above and other problems by allowing multiple software application modules to share an object of a software application. According to one embodiment, each of a number of multiple software applications may be associated with a LOB system and may be associated with a solution ID. An application with which the object is being created or edited may receive a request to establish a first binding between the object and a first LOB entity instance for a first software application module. The first binding between the object and the first LOB entity instance may then be established. The application may further receive a request to establish a second binding between the object and a second LOB entity instance for a second software application module. The second binding between the object and the second LOB entity instance may be established when the first and second software application modules have matching solution IDs and compatible sharing levels to the object. The application may therefore establish user interface and data sharing between the first and second LOB entity instances and the object.

According to another embodiment, a user may request to establish a first binding between the object and a first LOB entity instance for a first application module. The user may be notified that the first binding between the object and the first LOB entity instance has been established. The user may request to establish a second binding between the object and a second LOB entity instance for a second application module. The user may be requested for an agreement of establishing the second binding when the first and second application modules have matching solution IDs and compatible sharing levels to the object. The user may deliver permission to the application to establish the second binding between the object and a second LOB entity instance.

According to another embodiment, an application may include a binding establish module that may be programmed to establish a first binding between an object and a first LOB entity instance for a first business application module. The binding establish module may also be programmed to establish a second binding between the object and a second LOB entity instance for a second business application module when the first and second business applications (BA) have matching solution IDs and compatible sharing levels to the object. The application may also include a sharing establish module that may be programmed to establish user experience sharing between the first and second LOB entity instances in the object.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIGS. 1-2 illustrate an example system where an application is arranged and configured to provide familiar user interfaces for a user through business applications to surface and access information and processes of line of business systems;

FIG. 3 is a block diagram illustrating the application system of FIGS. 1-2 that includes a solution manifest associated with an application business application;

FIG. 4 is a block diagram illustrating the application system of FIGS. 1-3;

FIG. 5 is an example user experience design illustrating groups created in related application business applications within a same tab;

FIG. 6 is another example user experience design illustrating task pane regions created within a same task pane for related application business applications;

FIG. 7 is a computing system for implementing aspects of the present disclosure;

FIGS. 8-9 illustrate a method of allowing multiple software applications to share an object of an application system; and

FIG. 10 illustrates another method of allowing multiple software applications to share an object of an application system.

### DETAILED DESCRIPTION

This disclosure will now more fully describe embodiments with reference to the accompanying drawings, in which specific embodiments are shown. Other aspects may, however, be embodied in many different forms and the inclusion of specific embodiments in the disclosure should not be construed as limiting such aspects to the embodiments set forth herein. Rather, the embodiments depicted in the drawings are included to provide a disclosure that is thorough and complete and which fully conveys the intended scope to those skilled in the art. When referring to the figures, like structures and elements shown throughout are indicated with like reference numerals.

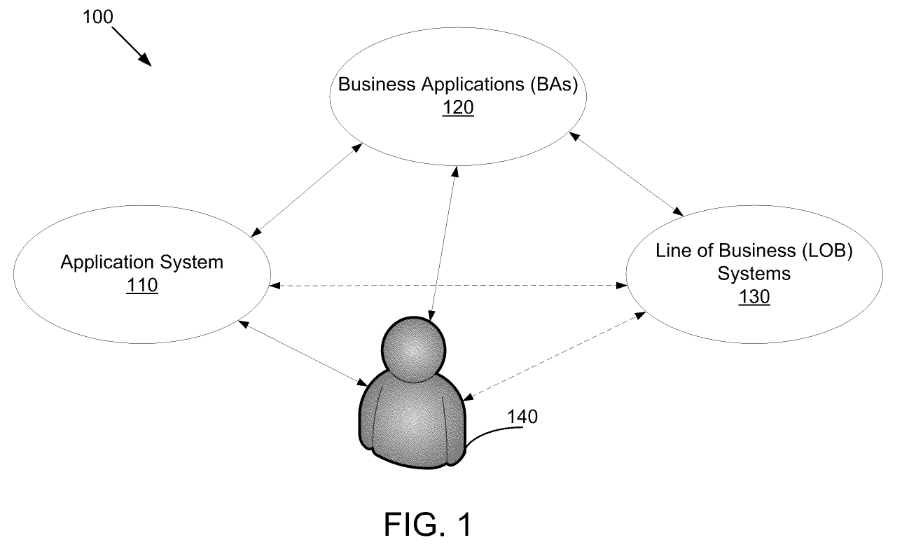

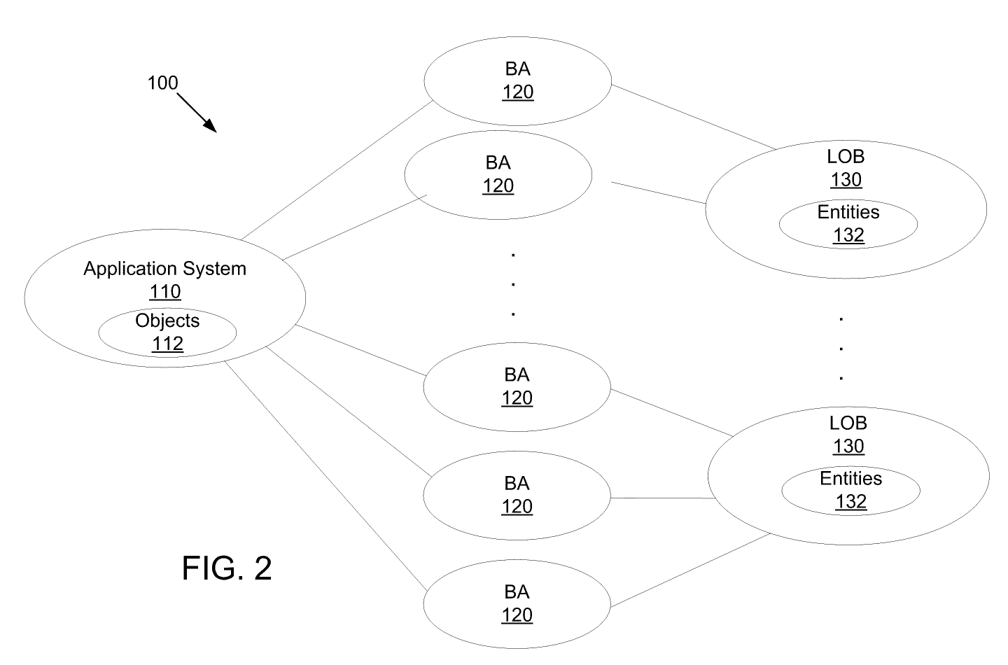

FIGS. 1-2 illustrate an example system 100 where an application system 110 is arranged and configured to provide familiar user interfaces for a user 140 through business applications (BAs) 120 to surface and access information and processes of LOB systems 130.

In one possible embodiment, the application system 110 may be a software application that provides one or more useful software application modules, or the application system 110 may be a software application suite that provides one or more useful software application modules (or, individual software applications) with which a variety of objects may be created and edited. An example of a suitable application system 110 is OFFICE manufactured by MICROSOFT CORPORATION that provides multiple software application modules/applications such as WORD (document objects), EXCEL (spreadsheet objects), POWERPOINT (slide presentation objects), and ACCESS (database objects). Another example of a suitable application system 110 is OUTLOOK manufactured by MICROSOFT CORPORATION that provides multiple software application modules/applications for creating and editing various objects, for example, emails tasks, contacts and appointments. A suitable application system 110 may be a single application that provides one or more useful application modules. For example, the application system 110 may be a word processing application, such as MICROSOFT WORD, that provides one or more modules for preparing and editing different types of objects (e.g., resume document module, letter document module, memorandum document module, and the like).

BAs 120 may be developed to combine the productivity tools in the application system 110 with information and processes defined in the LOB systems 130 so that a user 140 may surface and access the information and processes in familiar user interfaces and environments of the application system 110. For example, a BA 120 may be developed for combining the productivity tools of a spreadsheet application, such as MICROSOFT EXCEL, with an associated LOB 130 (e.g., a quarterly sales management module) for accessing and surfacing in the spreadsheet application and its associated user interface information from the LOB 130. For example, as will be understood from the discussion below, according to an embodiment, a BA 120 may be developed that would cause the example spreadsheet application to have access to the example LOB (quarterly sales management module), and the familiar user interface of the example spreadsheet application may be altered by the BA 120 to allow the information from the associated LOB to be accessed via the user interface of the example spreadsheet application so that the information from the LOB may be utilized in a spreadsheet prepared and edited with the spreadsheet application. For example, integration of the example BA with the example spreadsheet application may cause a tab or button to be presented in the user interface of the spreadsheet application that allows a user to import data from the associated LOB directly into a spreadsheet rather than requiring the user to navigate to a data repository for the LOB to retrieve the needed data for copying or otherwise integrating with the spreadsheet. Thus, the BAs include any suitable software applications or modules that allow information from a LOB process or system to be integrated with an application system or module 110 as described herein.

The LOBs 130 may include any software applications, data repositories, or the like that include or are associated with information that may be integrated with an object (e.g., document, spreadsheet, data file, etc.) prepared and edited with a given application system or module 110. For example, as described above an LOB 130 may include such entities as sales management modules, employee records modules, customer relationship management (CRM) modules, supply chain management (SCM) modules, human resources (modules) and the like that may contain information that may be desired for integration with an object being created or edited by a given application system or module. As should be appreciated, the LOBs listed above are for purposes of example and are not limiting of the vast number of LOB modules and related information types that may be integrated with an application system 110 via one or more BAs, as described herein.

Referring to FIG. 2, application objects 112 of the application system 110 may have copies of or references to LOB information and actions within them. On the other hand, the LOB systems 130 may maintain some state about a particular application user 140 or the application objects 112 of that user. The above shared information between the application system 110 and the LOB systems 130 may be synchronized whenever there are relevant changes in either the LOB systems 130 or in the application system 110.

In addition, there may be multiple LOB entities 132 with information and processes in multiple LOB systems 130 that are relevant to a particular application object 112. In other words, a single application object 112 may be relevant to multiple LOB entities 132. Different BAs may be developed to deal with different LOB modules or systems 130 since those LOB modules and systems 130 may need different kinds and levels or expertise.

The BA 120 may extend an application object 112 in a special way that is associated with a LOB functionality being exposed by that BA 120. The BA may expect that its extension is preserved when other BAs 120 extend the same application object 112. The BA 120 may also expect that the user experience in the application system 110 does not degrade when other BAs extend the same application object. Finally, the BA 120 may expect that if it needs to share information or actions with other BAs, there may be well defined ways to achieve the interaction without compromising security or privacy. For example, a first business application (BA) may allow for the integration of sales information from a given LOB module to a particular spreadsheet document (object) and a separate BA may extend the functionality of information associated with a separate LOB module (for example, marketing costs) to the same spreadsheet document. As set out above the two BAs may share information and actions, and the extension of the second BA to the same object (spreadsheet document in this example) does not alter the user experience in terms of user interface architecture or layout associated with the first BA.

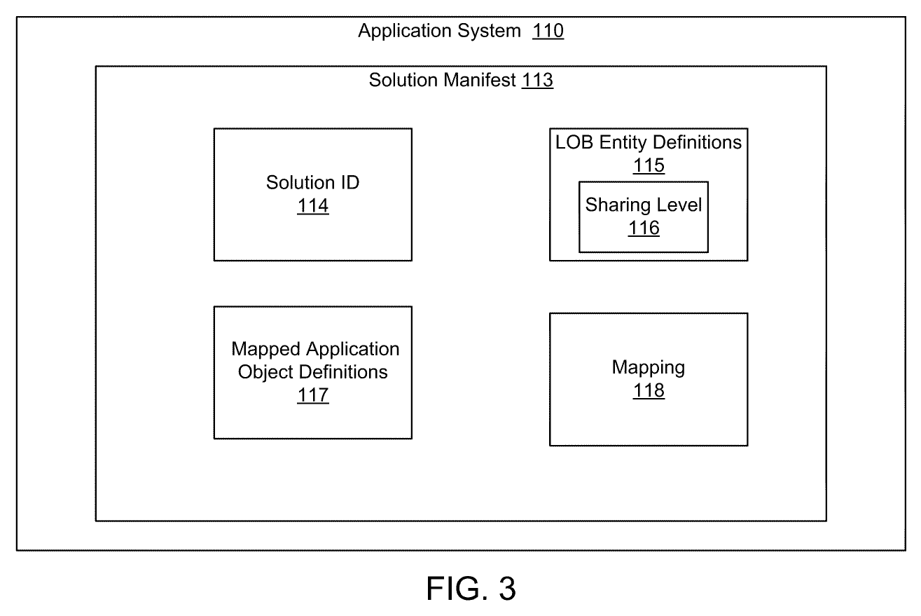

FIG. 3 is a block diagram illustrating the application system 110 of FIGS. 1-2 that includes a solution manifest 113 associated with a BA 120. The application system 110 may provide a solution manifest 113 for each BA 120. The solution manifest 113 may be a piece of metadata in an XML format that identifies component-binaries (DDLs, EXEs, etc.), reference binaries, configuration files, registry settings, and resources files.

The solution manifest 113 may include a solution ID 114 which may identify a BA 120. The solution ID 114 may be part of the solution manifest 113 that is typically signed by the vendor. Typically, all BAs 120 built for a same LOB system 130 or a same vendor may have a same solution ID 114.

The solution manifest 113 may include a list of LOB entities definitions 115 and corresponding (mapped) application object definitions 117. Along with the entities definitions, the solution manifest 113 may contain information of mapping 118 which may include each property mapping, the direction of the mapping, and information about whether the mapping requires the BA (hence the LOB entity) to be an exclusive or shared write owner (discussed below) of the application property.

A sharing level 116 may be contained in the LOB entities definitions 115 for each entity for a BA 120 to indicate what level of sharing it would permit. The BAs 120 that want to share an application object may participate by writing no special code. The sharing possibilities are specified in the solution manifest 113, with the application system 110 doing all the work to enable the sharing at run-time. Typically, there are four sharing levels defined for the BA to use an application object: “none”, “exclusive-write”, “read-only”, and “shared-write”. Each of the sharing levels is discussed below respectively.

Sharing level “none”: the BA may have a full control of the application object which it uses. If a BA shares with level equal to “none”, then the application system 110 may not allow any other BAs to share that application object.

Sharing level “exclusive-write”: The BA may have a full write-control of related properties of the application object, but it may tolerate not being able to write the others in a shared scenario. “Exclusive-write” owners may prevent conflicting updates from being triggered in sharing scenarios, and may not require that updates be done in any particular order among multiple BAs that want to update the same property in an application object. Since each such property has only one “exclusive-write” owner, sharing is disabled between two BAs that indicate they want to “exclusive-write” the same application object property.

Sharing level “read-only”: The BA may participate as a “downstream” receiver of information from the application object, and is not allowed to update the application object in a shared scenario.

Sharing level “shared-write”: The BA may write the properties of the application object, and may permit another BA to write the same properties. For example, if both BA “A” (e.g., Leave Management) and “B” (e.g. Travel Management) have a sharing level of “shared-write” to a property “P” (e.g., Location) of an application object “O” (e.g., appointment in a calendar application), then if A changes P, B will see the change O as well; and if B changes P, A will see the change to O. If A's change to P is not acceptable by B (due to LOB business process failure, etc.), an error will be triggered to the user and B will be removed from sharing the application object O. Instead, a copy O′ will be created from O, which has identical values for all properties like P, but will be associated with business application B alone. The equivalent behavior is triggered for changes to B that are not acceptable to A.

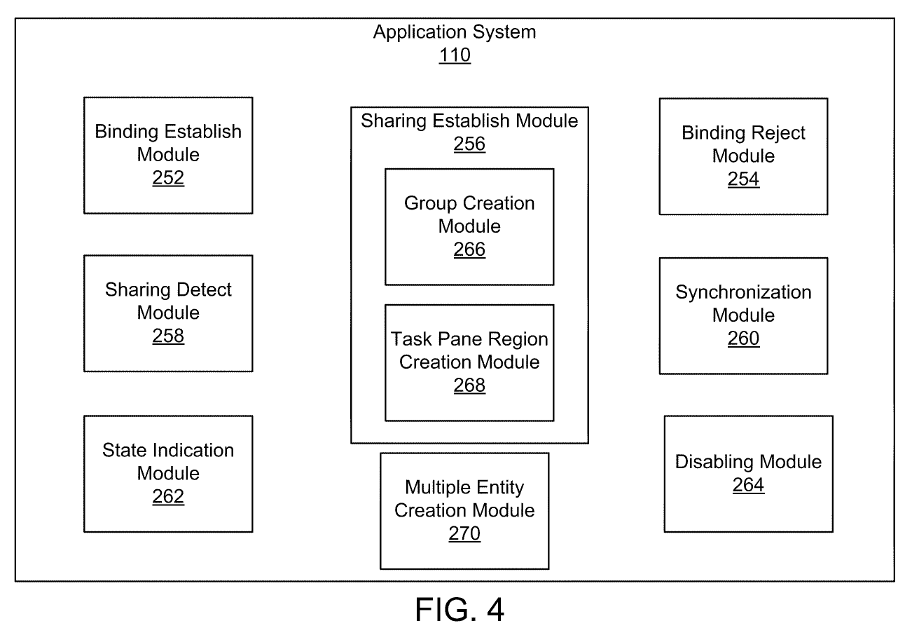

FIG. 4 is a block diagram illustrating the application system 110 in FIGS. 1-3. The application system 110 allows multiple BAs 120 to share an application object 112 of the application system 110. As discussed above, the application object 112 may be an application document as created and/or edited by applications/modules like MICROSOFT WORD, EXCEL, POWERPOINT, INFOPATH, and the like. Similarly, the application object 112 may by objects created by other applications (for example, calendar applications) such as emails, tasks, contacts and appointments. As mentioned above, the LOB system 130 may have one or more LOB entities 132. Each BA 120 may be associated with a solution ID.

The application system 110 may provide each of the multiple BAs a solution manifest to store the corresponding solution ID information and LOB entity definitions in a piece of metadata in an XML format respectively. In one possible embodiment, BAs built for a LOB system from a same vendor have a same ID. On the other hand, BAs built from different vendors have different IDs.

As discussed above in FIG. 3, the sharing possibilities are specified in the solution manifest by using a sharing level for a BA 120 to indicate what level of sharing it would permit. Typically, as discussed above, there are four sharing levels defined for the BA to use an application object: “none”, “exclusive-write”, “read-only”, and “shared-write”.

The application system 110 may include a binding establish module 252 and a sharing establish module 256. The binding establish module 252 may be programmed to establish a first binding between an application object and a first LOB entity instance where the first LOB entity may be defined in a first solution manifest for a first BA. In one possible embodiment, the application system 110 may allow a user to create a new bound application object. In another possible embodiment, the application system 110 may allow a user to bind an existing unbound application object. For example, the user may create an application object according to the normal programming of the application system or module 110, a “Bind” function may be provided for allowing a user to choose which LOB entity to which to extend to or associated with the application object.

The binding establish module 252 may be programmed to establish a second binding between the object and a second LOB entity instance defined in a second solution manifest for a second application when the first and second BAs have matching solution IDs and compatible sharing levels to the application object.

The sharing establish module 256 may be programmed to establish user experience sharing between the first and second LOB entity instances in the application object after the bindings between the application object and the first and second LOB entities instances are accomplished.

The sharing establish module 256 may include a group creation module 266 programmed to create groups within a same user interface control or button (e.g., selectable tab) for related BAs such as the above first and second BAs with bound LOB entities to a same application object. Specifically, each BA that wants to collaborate with another related BA may create a group for itself within the same user interface control as the related BA. In one possible embodiment, the user interface control or button name may be included that reflects the relationship between the BAs as being created by the same vendor (this control or button name may be extracted from the vendor's name, or the BA name). For example, in the DUET product developed by MICROSOFT CORPORATION AND SAP, a user interface tab may be called “Duet”, and the individual groups within the tab may be named after a particular business solution (e.g., “Leave Management”, “Time Tracking”, “Travel”, “ERecruiting”, etc.). In addition, each BA may be shown in a user interface grouping of buttons or controls when a user desires to enable that BA on a given application object. For example, if a the above example “Duet” BA is enabled, a button or control for each of the example solutions of “Leave Management”, “Time Tracking”, “Travel”, “ERecruiting” may be displayed in a user interface for the document being created and/or edited to allow the user to utilize the associated BA to, in turn, utilized LOB information associated with each solution type. On the other hand, the BA may hide the grouping of buttons or controls if the user does not want that BA enabled on that application object. This dynamic function makes the user interface and user experience better when the groups bring related BAs together.

The sharing establish 256 module may also include a task pane region creation module 268 that may be programmed to create task pane regions within the same task pane for related BAs such as the above first and second BAs with bound LOB entities to a same application object. Specifically, a BA may collaborate with another related BA to create a task pane region for itself within the same task pane as the related BA.

The application system 110 may include a binding reject module 254 programmed to reject establishment of the second binding when the first and second BAs do not have matching solution IDs or compatible sharing levels to the application object.

The application system 110 may also include a sharing detect module 258 that may be programmed to detect whether the application object is being shared in any BAs. The sharing detect module 258 may also be programmed to detect the level of sharing of all BAs that are sharing that application object.

The application system 110 may include a synchronization module 260 that may be programmed to synchronize appropriate portions of the application object when any related LOB entity changes.

The application system 110 may further include a state indication module 262 that may be programmed to indicate to a user that the application object is in an inconsistent state when the synchronization is not completed. On the other hand, when the synchronization is completed, the state indication module 262 may indicate to the user that the application object is in a consistent state.

The application system 110 may also include a disabling module 264 that is programmed to disable sharing of the application object with a BA in response to a user action or a synchronization error. Specifically, the disabling module 264 may disable sharing of an application object with a BA due to an explicit user action in the application object user interface. In addition, when there are synchronization errors due to incompatible changes to shared properties, the disabling module 264 may disable sharing of the application object with the BA. After disabling sharing of the application object, an independent copy of the application object may be created for use by the BA. If a binding between an application object and an LOB entity instance in a BA is removed, the existing LOB information stored in the application object for the LOB entity instance is removed. If each binding between the application object and any LOB entity instance is removed, the entire LOB entity information mapped to the object is removed.

The application system 110 may also include a multiple entity creation module 270 that may be programmed to create application objects that contain multiple LOB entity types using a single user interface. This allows the user to create multiple bindings between the LOB entities and the application object at one shot. This also allows the application system 110 to present valid type combinations to the user at creation time, and detect invalid type combinations at this time, as opposed to discovering invalid combinations only after a part of the binding has already been created.

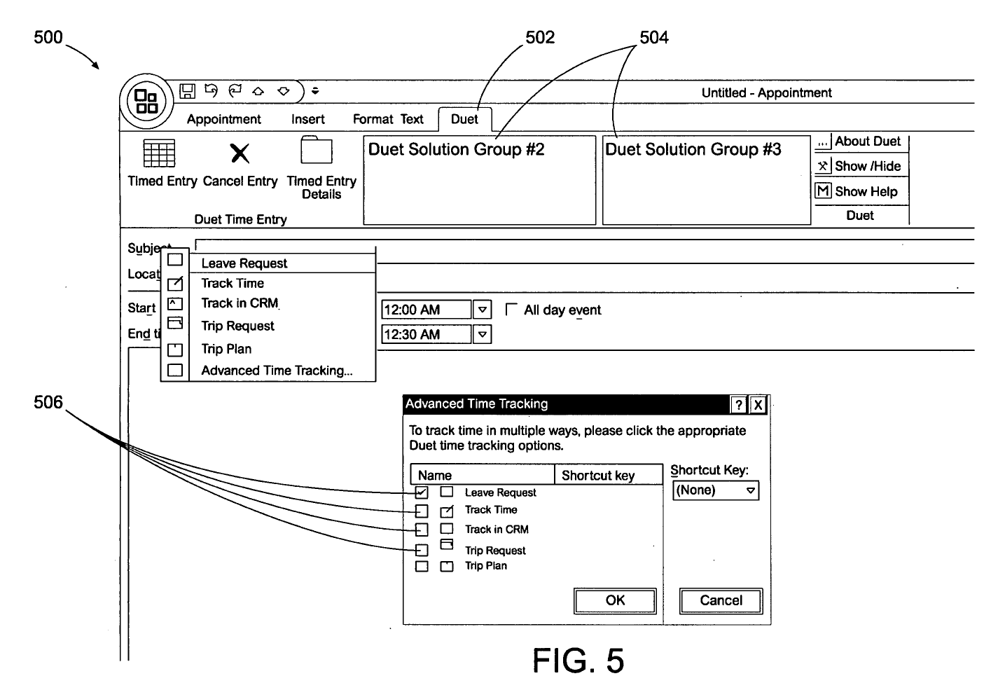

FIG. 5 is an example user interface 500 illustrating groups of buttons or controls for related BAs displayed in relation to a single user interface selectable tab (for example, a “Duet” tab. The user interface 500 also illustrates a multiple entity type grouping of buttons or controls where multiple Bas are associated with the selectable user interface tab 502. In the user interface 500, the example tab 502 (e.g., “Duet”) is created and displayed for all BAs that are associated with DUET application. Within the “Duet” tab, there are solution groups 504 created for related BAs. In addition, if those solutions create objects of composite types (for example, as does the “Duet Time Entry” group), the object creation user interface (under “Advanced Time Tracking”) allows multiple selections 506. The multiple selections 506 may be done at any time (not just when creating a first DUET extension to a base application object (for example, in this case, an appointment object).

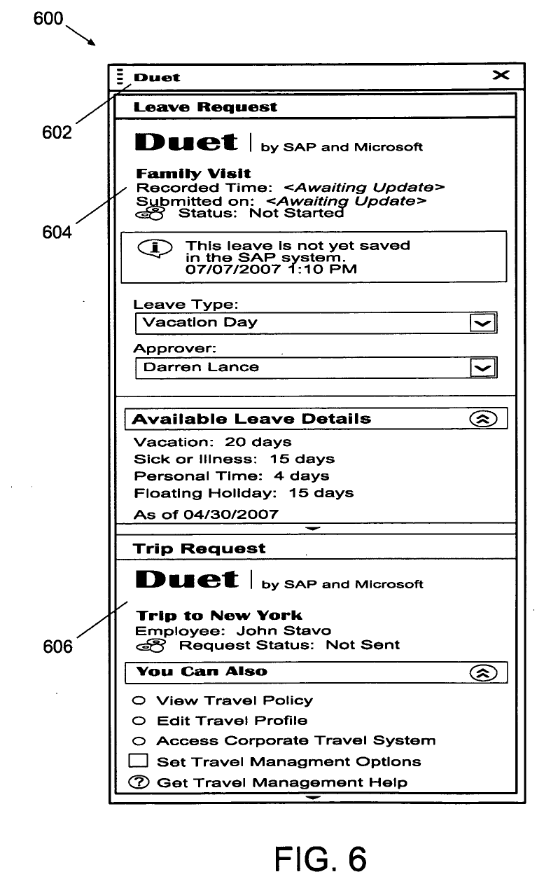

FIG. 6 is an example user interface 600 illustrating multiple task pane regions created within a same task pane for related BAs. In the user interface 600, task pane regions 604, 606 (for “Leave Request” and “Trip Request”) are within a same task pane 602 after the user chooses two items from the “Advanced Time Tracking” dialog illustrated in FIG. 5, for example, “Leave Request” and “Trip Request.” Sharing the task pane allows for BAs to collaborate better and allows better use of the display space.

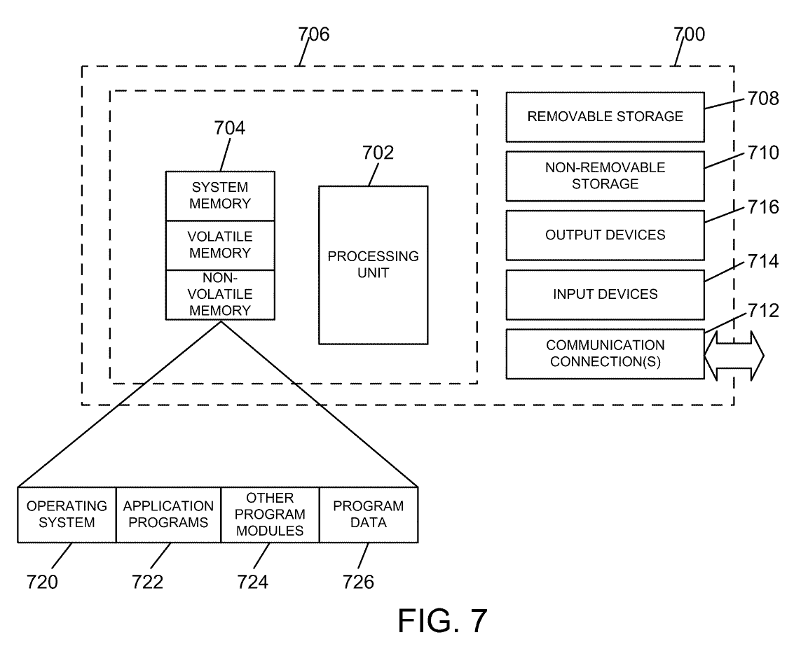

FIG. 7 is a computing system 700 for implementing aspects of the present invention. In its most basic configuration, computing system 700 typically includes at least one processing unit 702 and memory 704. Depending on the exact configuration and type of computing system, memory 704 may be volatile (such as RAM), non-volatile (such as ROM, flash memory, etc.) or some combination of the two. This most basic configuration is illustrated in FIG. 7 by dashed line 706. Additionally, computing system 700 may also have additional features/functionality. For example, computing system 700 may also include additional storage (removable and/or non-removable) including, but not limited to, magnetic or optical disks or tape. Such additional storage is illustrated in FIG. 7 by removable storage 708 and non-removable storage 710. Computer storage media includes volatile and nonvolatile, removable and non-removable media implemented in any method or technology for storage of information such as computer readable instructions, data structures, program modules or other data. Memory 704, removable storage 708 and non-removable storage 710 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that may be used to store the desired information and which can be accessed by computing system 700. Any such computer storage media may be part of computing system 700.

Computing system 700 may also contain communications connection(s) 712 that allow the computing system to communicate with other devices. Communications connection(s) 712 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Computing system 700 may also have input device(s) 714 such as keyboard, mouse, pen, voice input device, touch input device, etc. Output device(s) 716 such as a display, speakers, printer, etc. may also be included. All these devices are well known in the art and need not be discussed at length here.

In some embodiments, memory 704 includes one or more of operating system 720, application programs 722, other program modules 724, and program data 726. For example, application programs 722 may be the application system 110 and the application business applications 120 of FIGS. 1-2. In some embodiments, global data, client-specific data, and transformation rules may each be stored in memory 704, removable storage 708, non-removable storage 710, or any other computer storage media described herein.

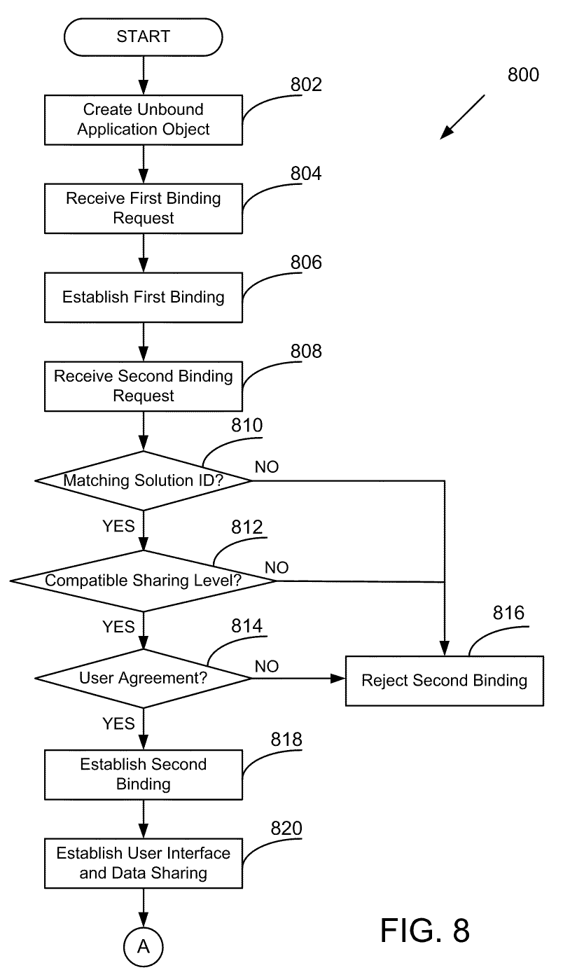

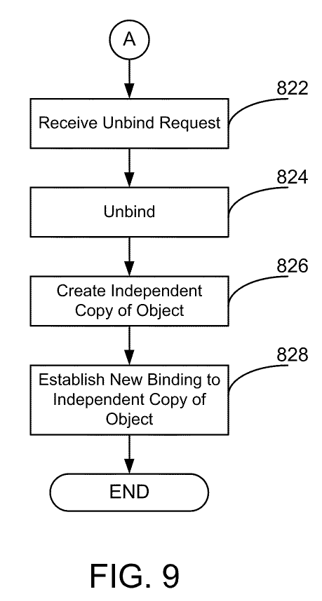

FIGS. 8-9 illustrate a method 800 of allowing multiple software applications to share an object of an application system. Each of the multiple applications may be associated with a LOB system that may have one or more entities. The application system may provide each of the software applications a solution manifest to store the corresponding solution ID information and LOB entity definitions in a piece of metadata in an XML format respectively. Each of the multiple software applications may be associated with a solution ID. The solution ID is typically signed from a vendor. Typically, software applications built for a LOB system from a same vendor may have a same ID. On the other hand, software applications built from different vendors may have different IDs respectively.

At operation 802, the application system creates an unbound object “O”. The object “O” may be an application document such as a word processing document, spreadsheet document, slide presentation document, and the like or another type of object such as an email, task, calendar appointment, etc. As should be appreciated from the discussion herein the present invention is applicable to any object created by a software application that may be associated with LOB information via one or more BAs.

At operation 804, the application system 110 receives a request to establish a first binding between the object “O” and a first LOB entity instance “A” where the first LOB entity may be defined in a first solution manifest for a first application or application module.

At operation 806, the application system establishes the first binding between the object “O” and the first LOB entity instance “A” through the first application.

At operation 808, the application system receives a request to establish a second binding between the object “O” and a second LOB entity instance “B” where the second LOB entity may be defined in a second solution manifest for a second application.

At operation 810 a determination is made as to whether the first and second applications have matching solution IDs. If operation 810 determines that the IDs do not match, then operational flow branches “No,” and operational flow proceeds to operation 816. Operation 816 rejects the second binding between the object “O” and the second LOB entity instance “B”. In other words, the double/multi binding between the object “O” and the first and second LOB entity instances “A” and “B” does not occur. Because the second binding from the object “O” to the second LOB entity instance “B” does not occur, the only way to bind the object “O” to the second LOB entity instance “B” would be to remove the binding between the object “O” and the first LOB entity instance “A”. Removing the binding between the object “O” and the first LOB entity instance “A” therefore would remove any LOB information in the object “O” due to the first LOB entity instance “A”. This ensures information isolation and protection.

If operation 810 determines that the solution IDs match, then operational flow branches “Yes,” and operational flow proceeds to operation 812. Operation 812 determines whether the first and second LOB entity instances “A” and “B” have compatible sharing levels. As discussed above, a sharing level may be “none”, “exclusive-write”, “read-only” or “shared-write”. Specifically, if the sharing level for “A” or “B” is “none”, the second binding between “O” and “B” will fail. Operational flow branches “No,” and operational flow proceeds to operation 816 as discussed above.

If the sharing level for “B” is “read-only”, the second binding between “O” and “B” will succeed. The application system may maintain that “A” (the first entity bound to “O”) is the exclusive-write owner for all the properties of “O”.

If the sharing level for “B” is “exclusive-write” or “shared-write” owner, and if the sharing level for “A” is “read-only”, a warning may be given to the user that the new entity “B” will take over the writes to the application object “O.” If the user agrees, the double/multi-binding occurs, but if the user does not agree, the double/multi-binding fails.

If the sharing level for “B” is “exclusive-write” or “shared-write” owner, and the sharing level for “A” is also “exclusive-write” or “shared-write” owner, the application system compares whether there is an application object property on “O” that is part of the write-owner property list for both “A” and “B”. If so, and either A or B marks that property as “exclusive-write”, the double/multi-binding fails, but if not, a warning is given to the user that the new entity “B” will now be able to write some of the properties of “O” that it shares with the existing entity “A” (the exact list of properties/ownerships will be available for the user to view). If the user agrees, the double/multi-binding occurs, but if the user does not agree, the double/multi-binding fails.

If operation 812 determines that “A” and “B” do not have a compatible sharing level as discussed above, then operational flow branches “No,” and operational flow proceeds to operation 816 as discussed above.

If operation 812 determines that “A” and “B” have a compatible sharing level as discussed above, then operational flow branches “Yes” and operational flow proceeds to operation 814. Operation 814 determines whether the user agrees to establish the second binding between “O” and “B”. In other possible embodiments, operation 814 is optional and the application system may not need to ask for an agreement from the user.

If operation 814 determines that the user does not agree to establish a binding between “O” and “B”, then operational flow branches “No” and operational flow proceeds to operation 816 as discussed above.

If operation 814 determines that the user agrees to establish a binding between “O” and “B”, then operational flow branches “Yes” and operational flow proceeds to operation 818. At operation 818, the application system establishes the second binding between the object “O” and the second LOB entity “B”.

At operation 820, the application system establishes user interface and data sharing between the first and second LOB entity instances “A” and “B” in the object “O”. Since the double/multi-binding between the object “O” and the second LOB entity instance “B” succeeds, in one possible embodiment, the user may see an extra user interface control/button group, extra regions in the task pane, extra regions in the main form, etc., that correspond to the newly established binding between “O” and “B”, in addition to the user interface components for the existing binding between “O” and “A”.

At operation 822, the application system receives a request to unbind the object “O” and, for example, the second LOB entity instance “B”. The unbind request may be from an explicit user unbind request or an implicit system error. The explicit user unbind request may be performed in the object user interface. The implicit system error may be a synchronization error due to incompatible changes to shared properties of the LOB entities.

At operation 824, the application system may remove the binding between the object “O” and the LOB entity instance “B” of the second software application. Removing the binding between the object and the LOB entity instance therefore removes any LOB information in the object “O” due to the LOB entity instance “B”. “B” will be removed from sharing the object “O”.

At operation 826, the application system creates an independent copy “O′” of the object “O”. The independent copy “O′” may be associated with “B” alone. At operation 828, the application system may establish a new binding between the independent copy “O′” and “B”.

The principles, concepts, and steps illustrated above in the method 800 will be well appreciated to apply to establishing three or more bindings between the object and three or more LOB entity instances, respectively, and to establishing sharing among them in the object.

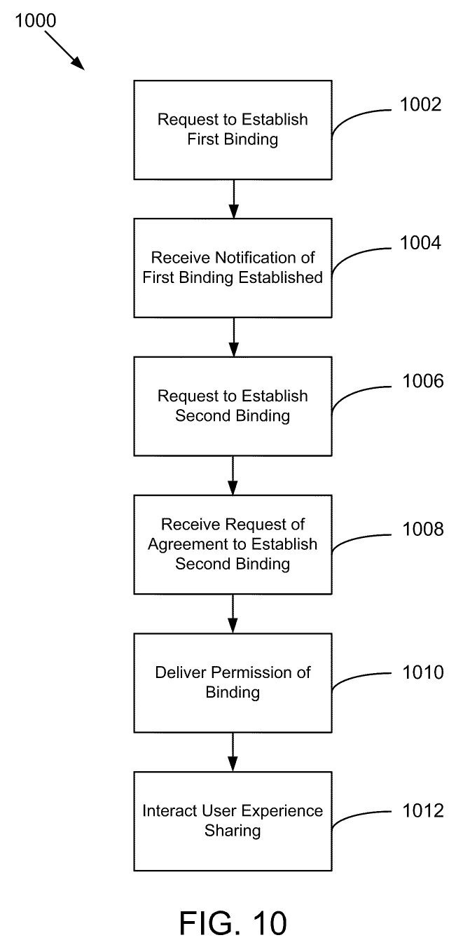

FIG. 10 illustrates a method 1000 of allowing multiple software applications to share an object of the application system. Each of the multiple applications may be associated with a LOB system that may have one or more entities. The application system may provide each of the software applications a solution manifest to store the corresponding solution ID information and LOB entity definitions in a piece of metadata in an XML format respectively.

At operation 1002, a user requests to establish a first binding between an unbound object and a first LOB entity instance where the first LOB entity is defined in a first solution manifest for a first application. At operation 1004, the user may receive a notification that the first binding between the object and the first LOB entity instance has been established.

At operation 1006, the user requests to establish a second binding between the object and a second LOB entity instance where the second LOB entity is defined in a second solution manifest for a second application. At operation 1008, the user may receive a request for an agreement of establishing the second binding when the first and second applications have matching IDs and compatible sharing levels to the object.

At operation 1010, the user delivers permission to the application system to establish the second binding between the object and a second LOB entity instance if the user agrees to the binding.

At operation 1012, a user interface may be provided to allow the user experience of sharing data and/or functionality between the first and second LOB entity instances in the object.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of allowing multiple software applications to share an object of an application system, wherein each of the multiple software applications is associated with a line of business (LOB) system and is associated with a solution ID, the method comprising:
receiving a request to establish a first binding between the object and a first LOB entity instance for a first software application;
establishing the first binding between the object and the first LOB entity instance;
receiving a request to establish a second binding between the object and a second LOB entity instance for a second software application;
establishing the second binding between the object and the second LOB entity instance when the first and second software applications have matching solution IDs and compatible sharing levels to the object; and
establishing user interface and data sharing between the first and second LOB entity instances in the object.

2. The method of claim 1, the method further comprising rejecting to establish the second binding when the first and second software applications have un-matching solution IDs.

3. The method of claim 1, the method further comprising rejecting to establish the second binding when the first and second software applications do not have compatible sharing levels to the object.

4. The method of claim 1, wherein establishing user interface and data sharing between the first and second LOB entity instances in the object includes creating groups within a same tab for the first and second applications.

5. The method of claim 1, wherein establishing user interface and data sharing between the first and second LOB entity instances in the object includes creating task pane regions within a same task pane for the first and second applications.

6. The method of claim 1, the method further comprising:
disabling sharing of the object with a software application in response to a user action or a synchronization error; and
creating an independent copy of the object for use by the software application.

7. A method of allowing multiple software applications to share an object of an application system, wherein each of the multiple software applications is associated with a LOB system and is associated with a solution ID, the method comprising:
requesting to establish a first binding between the object and a first LOB entity instance for a first application;
receiving a notification that the first binding between the object and the first LOB entity instance has been established;
requesting to establish a second binding between the object and a second LOB entity instance for a second application;
receiving a request for an agreement of establishing the second binding when the first and second applications have matching solution IDs and compatible sharing levels to the object;
delivering permission to the application system to establish the second binding between the object and a second LOB entity instance; and
interacting user experience sharing between the first and second LOB entity instances in the object.

8. The method of claim 7, wherein interacting user experience sharing between the first and second LOB entity instances in the object includes interacting user interface controls groups created within a same user interface component for the first and second applications.

9. The method of claim 8, wherein one of the first and second applications displays a corresponding user interface controls group when the user causes an enablement of the one of the first and second applications on the object, and hides the corresponding user interface controls group if the user causes a non-enablement of the one of the first and second applications on the object.

10. The method of claim 7, wherein interacting user experience sharing between the first and second LOB entity instances in the object includes interacting task pane regions within a same task pane for the first and second applications.

11. The method of claim 7, the method further comprising sending a request to disable sharing of the object with a software application.

12. An application system for allowing multiple business applications (BAs) to share an application object of the application system, wherein each of the multiple BAs is associated with a LOB system and is associated with a solution ID, the application system comprising:
a binding establish module programmed to establish a first binding between the application object and a first LOB entity instance for a first BA, the binding establish module programmed to establish a second binding between the application object and a second LOB entity instance for a second application when the first and second BAs have matching solution IDs and compatible sharing levels to the application object; and
a sharing establish module programmed to establish user experience sharing between the first and second LOB entity instances in the application object.

13. The application system of claim 12, wherein the application system provides each of the multiple BAs a solution manifest to store the corresponding solution ID information and LOB entity definitions in a piece of metadata in an XML format respectively.

14. The application system of claim 12, wherein BAs built for a LOB system from a same vendor have a same ID and BAs built from different vendors have different solution IDs.

15. The application system of claim 12, wherein each of the sharing level is selected from the group comprising: none, exclusive-write, read-only and shared-write.

16. The application system of claim 12, the system further comprising a sharing detect module programmed to detect whether the application object is being shared in any BAs.

17. The application system of claim 12, the system further comprising a synchronization module programmed to synchronize appropriate portions of the application object when any related LOB entity changes.

18. The application system of claim 17, the system further comprising a state indication module programmed to indicate to a user that the application object is in an inconsistent state when the synchronization is not completed.

19. The application system of claim 18, wherein the state indication module indicates to the user that the application object is in a consistent state when the synchronization is completed.

20. The application system of claim 12, the system further comprising a disabling module programmed to disable sharing of the application object with a BA in response to a user action or a synchronization error.
